(19) United States
(12) Patent Application Publication
(10) Pub. No.: US 2018/0327179 A1
(43) Pub. Date: Nov. 15, 2018

(54) Refrigerated Transport System with Refrigerant Dilution

(71) Applicant: Carrier Corporation, Palm Beach Gardens, FL (US)

(72) Inventors: Paul Papas, West Hartford, CT (US); Ciara N. Poolman, Syracuse, NY (US); Larry D. Burns, Avon, IN (US); Giorgio Rusignuolo, Manlius, NY (US); Renee A. Eddy, Manlius, NY (US); Michael J. Dormer, Fabius, NY (US); Robert A. Chopko, Baldwinsville, NY (US); Jeffrey J. Burchill, Baldwinsville, NY (US); Ivan Rydkin, Rochester, NY (US)

(73) Assignee: Carrier Corporation, Palm Beach Gardens, FL (US)

(21) Appl. No.: 15/774,750

(22) PCT Filed: Nov. 9, 2016
(86) PCT No.: PCT/US2016/061061

§ 371 Date: May 9, 2018

Related U.S. Application Data
(60) Provisional application No. 62/253,070, filed on Nov. 9, 2015.
(60) Provisional application No. 62/292,692, filed on Feb. 8, 2016.

(51) Int. Cl. B65D 88/74; F25D 11/00; B65D 90/00; F25B 49/00; F25D 29/00

(52) U.S. Cl. CPC B65D 88/745; F25D 11/003; B60P 3/20; F25B 49/005; F25D 29/003; B65D 90/008

(57) ABSTRACT

A refrigerated transport system (20) comprises: a body (22) enclosing a refrigerated compartment. A refrigeration system (30) comprises: a charge of refrigerant; a compressor (36) for driving the refrigerant along a refrigerant flowpath (34); a first heat exchanger (38) along the refrigerant flowpath and positioned to reject heat to an external environment in a cooling mode; and a second heat exchanger (42) along the refrigerant flowpath and positioned to absorb heat from the refrigerated compartment in the cooling mode. The refrigerated transport system has a detector (232) for detecting leakage of the refrigerant.

### CROSS-REFERENCE TO RELATED APPLICATIONS

Benefit is claimed of U.S. Patent Application No. 62/292,692, filed Feb. 8, 2016, and entitled “Refrigerated Transport System with Refrigerant Dilution” and U.S. Patent Application No. 62/253,070, filed Nov. 9, 2015, and entitled “Refrigerated Transport System with Refrigerant Safety”, the disclosures of which are incorporated by reference herein in their entirety as if set forth at length.

### BACKGROUND

The disclosure relates to refrigerated transport systems such as intermodal containers. More particularly, the disclosure relates to refrigerant safety in such refrigerated transport systems.

An exemplary refrigerated intermodal container (also known as a shipping container or intermodal shipping container) has an equipment module at one end of the container. The equipment module contains a vapor compression system having a compressor, a heat rejection heat exchanger downstream of the compressor along a refrigerant flow path, an expansion device, and a heat absorption heat exchanger. One or more first fans may drive an external air flow across the heat rejection heat exchanger. One or more second fans may drive an internal air flow across the heat absorption heat exchanger. In various implementations, for powering the container, there may be a power cord for connecting to an external power source. For ease of manufacture or service, the equipment module may be pre-formed as a module mateable to a remainder of the container body (e.g., insertable into an open front end of the body). One example of such a container refrigeration system is sold by Carrier Corporation of Farmington, Conn. under the trademark ThinLINE. An example of such a system is seen in U.S. Patent Application 62/098144, of Rau, filed Dec. 30, 2014 and entitled “Access Panel”, the disclosure of which is incorporated in its entirety herein as if set forth at length. Additionally, refrigerated truck boxes, refrigerated railcars, and the like may have refrigeration systems with different forms or degrees of modularity.

There has been a general move to seek low global warming potential (GWP) refrigerants to replace conventional refrigerants such as R-134a. A number of proposed and possible future replacement refrigerants having low GWP also may have higher flammability and/or toxicity levels than prior refrigerants. These include various hydrofluorocarbon (HFC) and hydrocarbon (HC) refrigerants. Background flame arrestor technology for use with flammable refrigerants is found International Publication No. WO2015/009721A1, published Jan. 22, 2015, the disclosure of which is incorporated herein in its entirety by reference as if set forth at length.

Additionally, Controlled Atmosphere (CA) containers are used to ship various perishable items. These may have sources of gases used principally to limit oxygen content within the container. One example is found in US Patent Application Publication 2015/0316521 A1, of Goldman, published Nov. 5, 2015 and entitled “Controlled Environment Shipping Containers”.

### SUMMARY

One aspect of the disclosure involves a refrigerated transport system comprising: a body enclosing a refrigerated compartment. A refrigeration system comprises: a charge of refrigerant; a compressor for driving the refrigerant along a refrigerant flowpath; a first heat exchanger along the refrigerant flowpath and positioned to reject heat to an external environment in a cooling mode; and a second heat exchanger along the refrigerant flowpath and positioned to absorb heat from the refrigerated compartment in the cooling mode. The refrigerated transport system has a detector for detecting leakage of the refrigerant.

In one or more embodiments of any of the foregoing embodiments, the refrigerated transport system further comprises a dilution gas source coupled to the detector.

In one or more embodiments of any of the foregoing embodiments, the dilution gas consists essentially of nitrogen.

In one or more embodiments of any of the foregoing embodiments, the refrigerated transport system further comprises an automatic valve coupled to control flow from the dilution gas source.

In one or more embodiments of any of the foregoing embodiments, the dilution gas source is coupled via the automatic valve to one or more outlets positioned along an equipment box duct.

In one or more embodiments of any of the foregoing embodiments: the dilution gas source comprises a cylinder having a first outlet and a second outlet; and a first said automatic valve is positioned to control flow from the first outlet and a second said automatic valve is positioned to control flow from the second outlet.

In one or more embodiments of any of the foregoing embodiments, the refrigerated transport system further comprises a controller coupling the detector to the automatic valve (612) to control flow from the dilution gas source.

In one or more embodiments of any of the foregoing embodiments, the controller is configured to: receive input from the detector; and responsive to reaching a threshold, open the automatic valve.

In one or more embodiments of any of the foregoing embodiments, the refrigerated transport system further comprises a first valve along the refrigerant flowpath and a second valve along the refrigerant flowpath and coupled to the detector.

In one or more embodiments of any of the foregoing embodiments, the first valve and the second valve are normally closed valves coupled to the detector to close responsive to detection by the detector of the refrigerant outside the refrigerant flowpath.

In one or more embodiments of any of the foregoing embodiments, the body comprises a pair of side walls; a top; a bottom; and one or more doors.

In one or more embodiments of any of the foregoing embodiments, the refrigerated transport system further comprises a locking mechanism having a first condition locking the doors and a second condition allowing opening of the doors and coupled to the detector.

In one or more embodiments of any of the foregoing embodiments, the locking mechanism is coupled to the detector to shift from the second condition to the first condition responsive to detection by the detector of the refrigerant outside the refrigerant flowpath.

In one or more embodiments of any of the foregoing embodiments, the locking mechanism is mounted inside the refrigerated compartment.

In one or more embodiments of any of the foregoing embodiments, the refrigerated transport system further comprises one or both of: an externally visible light coupled to the detector; and an externally audible alarm coupled to the detector.

In one or more embodiments of any of the foregoing embodiments, the refrigerated transport system further comprises a battery-powered ventilation fan.

In one or more embodiments of any of the foregoing embodiments, the refrigerated transport system, further comprises: a first electric fan positioned to drive an air flow across the first heat exchanger; and a second electric fan positioned to drive a recirculating air flow from the refrigerated compartment across the second heat exchanger.

In one or more embodiments of any of the foregoing embodiments, the refrigerated transport system further comprises a battery, distinct from a battery of a main controller, if any, and coupled to the detector.

In one or more embodiments of any of the foregoing embodiments, a refrigerant charge of the vapor compression loop has a flammability classification of at least mildly flammable.

In one or more embodiments of any of the foregoing embodiments, a refrigerant charge of the vapor compression loop has a flammability classification of highly flammable.

In one or more embodiments of any of the foregoing embodiments, a refrigerant charge of the vapor compression loop comprises at least 50% by weight one or a combination of R-1234ze(E), R-1234yf, R-32, propane, and ammonia.

In one or more embodiments of any of the foregoing embodiments, a refrigerant charge of the vapor compression loop comprises at least 3% by weight propane.

In one or more embodiments of any of the foregoing embodiments, a refrigerant charge of the vapor compression loop comprises at least 50% by weight propane.

In one or more embodiments of any of the foregoing embodiments, the refrigerated transport system is a refrigerated intermodal shipping container wherein: the one or more doors comprise a pair of hinged doors at a first end of the body; and the refrigeration system is mounted in an equipment box at a second end of the body opposite the first end.

In one or more embodiments of any of the foregoing embodiments, the detector comprises a non-dispersive infrared sensor.

In one or more embodiments of any of the foregoing embodiments, a controller is coupled to the detector so as to, responsive to said detecting leakage of the refrigerant, at least one of: vent the refrigerated compartment; introduce a dilution gas from a gas source; lock at least one door of the one or more doors; isolate a portion of the refrigeration flowpath; and provide an audible and/or visible indication of the detection.

In one or more embodiments of any of the foregoing embodiments, a method for operating the refrigerated transport system comprises, responsive to said detecting leakage of the refrigerant, at least one of: venting the refrigerated compartment; introducing a dilution gas from a gas source; locking at least one door of the one or more doors; isolating a portion of the refrigeration flowpath; and providing an audible and/or visible indication of the detection.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a cutaway view of a refrigerated cargo container.

FIG. 2 is a rear view of the refrigerated cargo container.

FIG. 3 is a schematic view of a refrigeration system of the refrigerated cargo container.

FIG. 4 is a front view of a refrigeration unit of the container of FIG. 1.

FIG. 5 is a schematic side cutaway view of the refrigerated cargo container.

FIG. 6 is a view of a locking handle of a door of the refrigerated cargo container and showing an exterior supplemental locking mechanism.

FIG. 7 is an interior view of an alternative door pair of the refrigerated cargo container showing an interior supplemental locking mechanism.

FIG. 8 is a partially schematic view of components of an inerting system.

Like reference numbers and designations in the various drawings indicate like elements.

### DETAILED DESCRIPTION

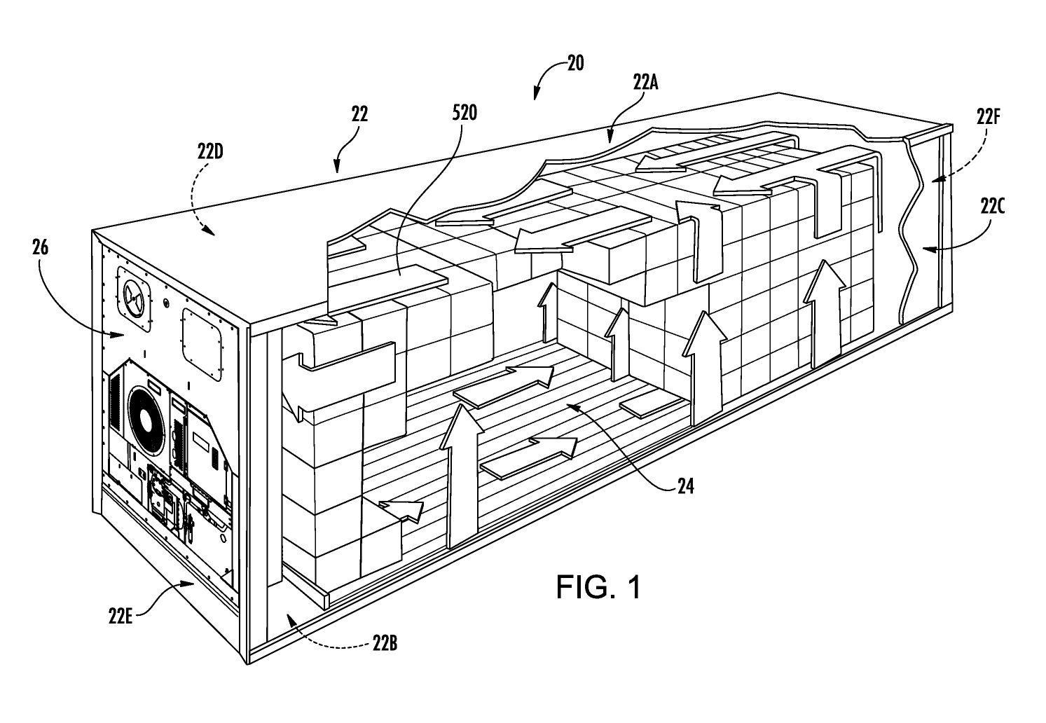

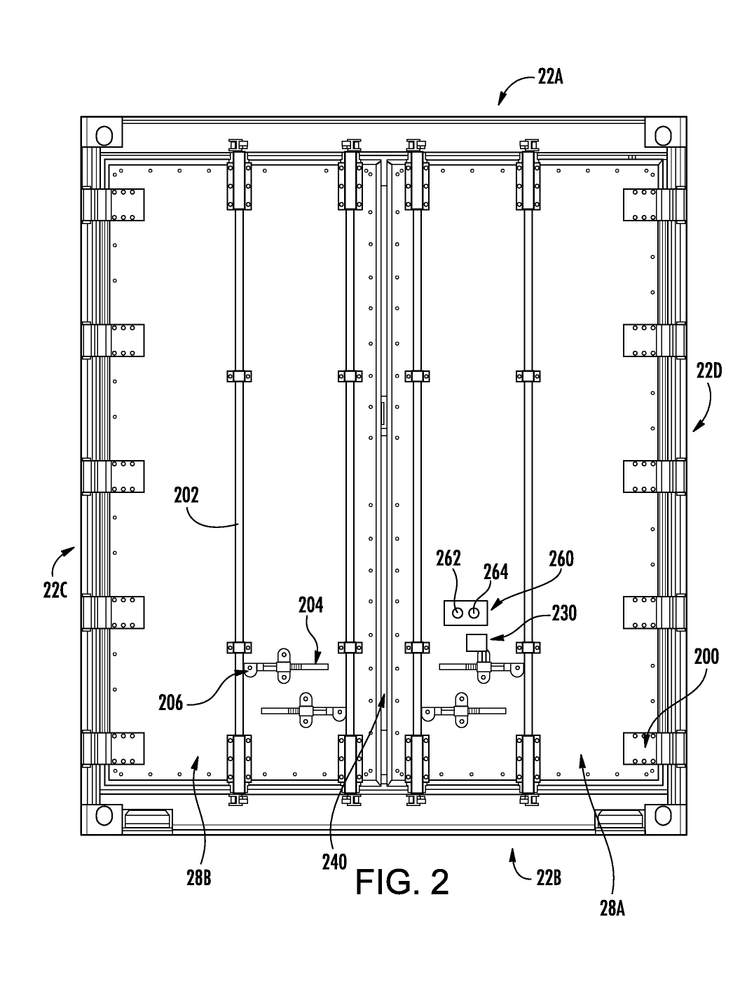

FIG. 1 shows an intermodal container 20 that may be shipped, trucked, trained or the like. The container has a body 22 enclosing an interior 24. The body and interior are formed essentially as right parallelepipeds. The body has a top 22A, a bottom 22B, a first side 22C, a second side 22D, a first end 22E and a second end 22F. The top, bottom, and sides may be an integral rigid metallic structural system. The first end may be closed by an equipment module 26 (“equipment box”). The second end may essentially be formed by a pair of oppositely hinged doors 28A, 28B (FIG. 2).

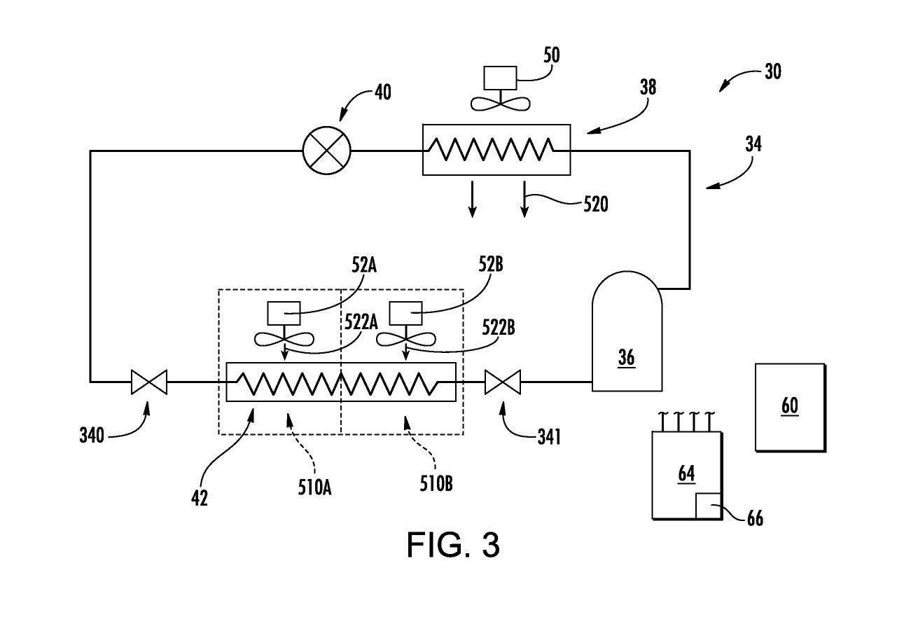

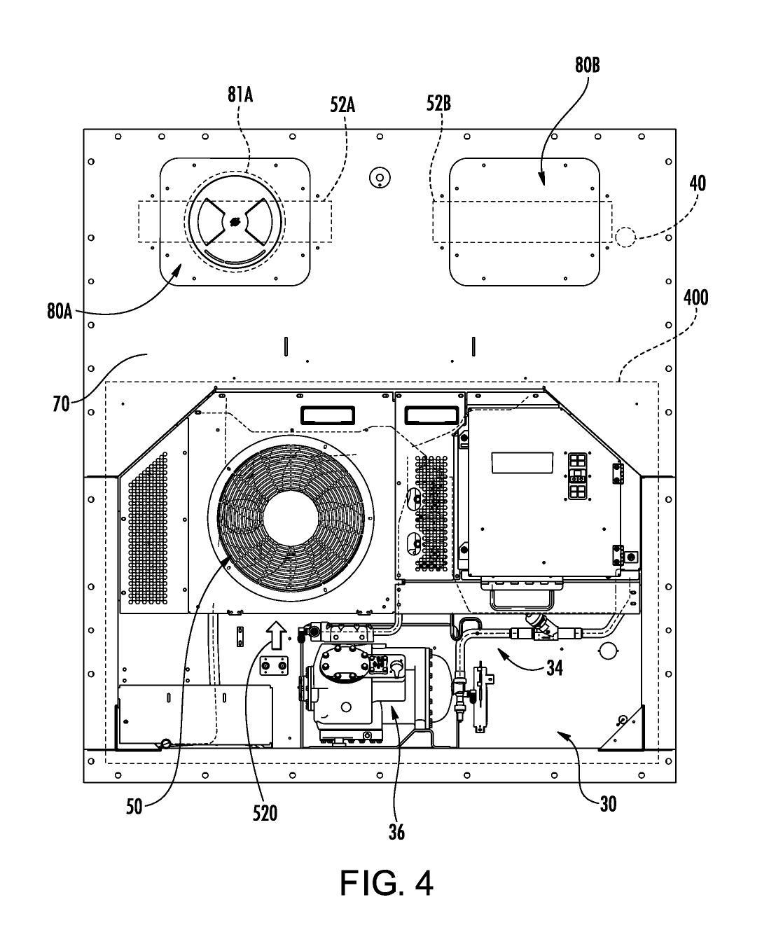

The equipment module contains a vapor compression refrigeration system 30 (FIG. 3). The illustrated example comprises, sequentially along a refrigerant flowpath 34, a compressor 36, a heat rejection heat exchanger 38, an expansion device 40 (e.g., electronic expansion valve, thermal expansion valve, orifice, or the like), and a heat absorption heat exchanger 42. One or more first fans 50 may drive an external air flow 520 across the heat rejection heat exchanger. One or more second fans 52A, 52B (FIGS. 3 and 4) may drive an internal air flow 522A, 522B along respective flowpaths 510A, 510B across the heat absorption heat exchanger.

In various implementations, for powering the container, there may be a power cord (not shown) for connecting to an external power source. Additionally, the container may be associated with a generator 60 (FIG. 3, e.g., having an internal combustion engine). For intermodal containers, the generator may be a part of an accessory “genset” that may separately mount to a vehicle (trailer or rail car) carrying the container. Other transport refrigeration systems such as dedicated trailers may integrate the generator into an equipment body mounted to the front of the trailer box. The refrigeration system may include a main controller 64 (e.g., having a processor, memory and storage for running a program to perform the required functions) powered by a main battery 66. The battery is typically a rechargeable battery that charges when the container is plugged into external power or a running genset.

For ease of manufacture or service, the equipment module may be pre-formed as a module mateable to a remainder of the container body (e.g., insertable into an open front end of the body).

The module 26 comprises a front panel 70 (FIG. 4). The panel 70 may have a plurality of openings of which some may be closed by various means. Two of the openings are along the respective air flowpaths 510A, 510B of the two evaporator fans 52A and 52B. These flowpaths may be isolated from each other or may merely be adjacent halves of a single flowpath (or may be a combination, separating and merging). In this example, the opening spans the fan, so that a portion of the opening is upstream of the fan and a portion of the opening is downstream. The openings are closed by respective access panels 80A, 80B (FIG. 4). The exemplary panel 80A includes a rotary gate valve (e.g., motorized) for venting for fresh air exchange. It may also have a small blower fan 81A to withdraw air from the flowpath 510A (or may rely on leakage across the adjacent evaporator fan). Other valve/gate structures may be provided. The illustrated panel 80B lacks any vent/valve and/or blower but may also have one.

The exemplary pair of rear doors 28A, 28B (FIG. 2) are hinged 200 along their outboard edges to the adjacent sides and meet at their inboard edges. To secure the doors in place, each door has a pair of vertically oriented locking bars 202 mounted in bushings for rotation about their central vertical axes. At upper and lower ends, each of the locking bars has a cam which may interact with an associated complementary keeper mounted in the rear header and rear sill respectively. The locking bars may rotate by approximately 90° or up to approximately 180° between a locked condition wherein the cams interlock with the keepers and an unlocked condition where the cams may pass free from the keepers as the doors are rotated between their opened and closed conditions.

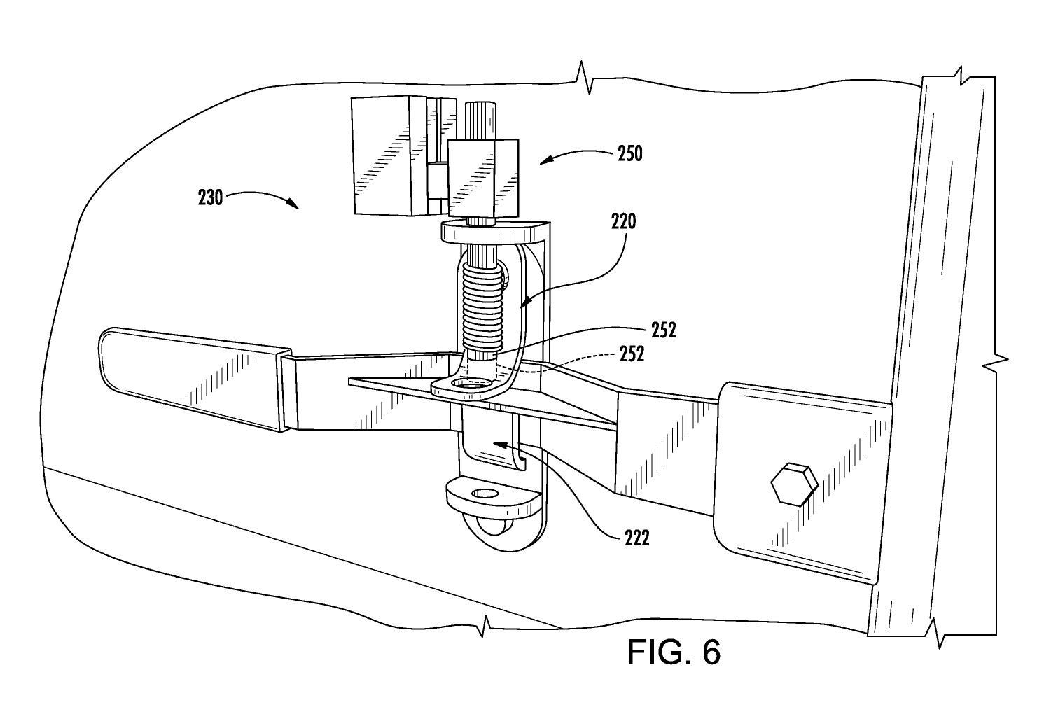

Each of the locking bars has mounted to it a handle 204 for rotating the bar. The handle has a proximal end mounted to the bar (e.g., by a pivot bracket 206) and a distal end at a hand grip. In the locked condition, the handle lies flat along the rear surface of the associated door. The handle may be held in place by a releasable catch 220 (FIG. 6) on the door. In some implementations, a retainer 222 on the door is associated with the catch. In that situation, an unlatching action involves releasing the catch, rotating the handle slightly upward (about a pivot axis of the pivot bracket) out of engagement with the retainer, and then rotating the handle outward about the axis of the locking rod to disengage the cams from the keepers. A locking/latching motion involves the reverse. In other exemplary implementations, the handle may be non-pivotally mounted to the locking rod so that unlocking the door does not require first raising the handle.

To address the use of hazardous or flammable refrigerant in the vapor compression system, one or more of several features may be added to a baseline (e.g., prior art) container body or included in the equipment module. Exemplary refrigerants have flammability and toxicity ratings of A3/B3, A2L/B2, or A2 under ANSI/ASHRAE Standard 34-2007. These include R-290 (propane) amongst other hydrocarbon refrigerants. A2L (non-toxic, mildly flammable) refrigerants include R-1234yf, R-1234ze(E), and R-32. A3 (non-toxic, highly flammable) refrigerants include propane. B2L (toxic, mildly flammable) refrigerants include ammonia. B3 (toxic, highly flammable) refrigerants include acetone and cyclopentane. The same ratings standards may be applied to refrigerant blends.

Flammable refrigerants used in HVAC/R applications may leak and migrate to undesirable regions such as confined spaces in the vicinity of the HVAC/R system. When the flammable refrigerants, in the presence of air or another oxidizer, are exposed to an ignition source, the potential for combustion events exists. The term flammability refers to the ability of a mixed refrigerant-air mixture, initially at ambient pressure and temperature conditions, to self-support flame propagation after a competent ignition source is removed. Such a flame or deflagration will propagate throughout the gaseous mixture provided that the composition of the mixture is within certain limits called the lower and upper flammability limits—LFL and UFL, respectively. The LFL represents the lowest refrigerant concentration that when well-mixed with air can ignite and propagate a flame at a given initial temperature and pressure condition. Similarly, a refrigerant's upper flammability limit (UFL) represents the highest refrigerant concentration with air that can propagate a flame.

For classification of a refrigerant as flammable or nonflammable, safety standards such as ANSI/ASHRAE Standard 34 have established testing methods such as ASTM E681 Standard Test Method for Concentration Limits of Flammability of Chemicals (Vapors and Gases) using a spark ignition source.

The degree of flammability can be assigned to one of three classes (1 or nonflammable, 2 or mildly flammable, and 3 or highly flammable) based on lower flammability limit testing, heat of combustion, and the laminar burning velocity measurement. A refrigerant can be assigned Class 2 if the refrigerant meets all three of the following conditions: (1) Exhibits flame propagation when tested at 140° F. (60° C.) and 14.7 psia (101.3 kPa), (2) Has an LFL >0.0062 lb/ft³ (0.10 kg/m³), and (3) Has a heat of combustion <8169 Btu/lb (19,000 kJ/kg). A refrigerant can be assigned Class 3 if the refrigerant meets both of the following conditions: (1) Exhibits flame propagation when tested at 140° F. (60° C.) and 101.3 kPa (14.7 psia), (2) Has an LFL ≥0.0062 lb/ft³ (0.10 kg/m³) or it has a heat of combustion that is ≥8169 Btu/lb (19,000 kJ/kg).

There is a need for an HVAC/R system or components that mitigates the spread of a flame upon ignition to other nearby combustible materials, mitigates the propagation of premixed deflagrations or explosions that can cause significant overpressure and structural damage or human injury in confined spaces, and/or quenches flames soon after ignition of refrigerant-air mixtures which may pose a risk to humans in the vicinity.

The total charge may consist essentially of one or more such refrigerants (e.g., allowing for industry standard levels of contaminants and additives such as corrosion inhibitors) or at least be 30% or 50% by weight such refrigerant(s). Propane offers efficiency and low cost. It or the other refrigerants may form the base refrigerant or a minority component in a blend. Blends containing propane or other refrigerants at levels of at least 3.0 weight percent may be used.

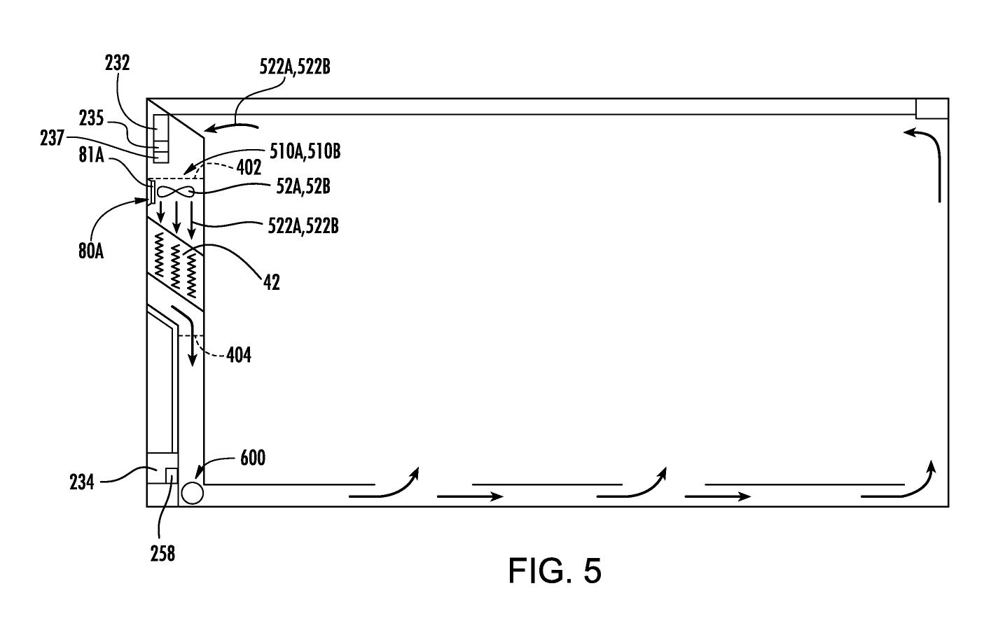

A first feature is an electronically or electrically controlled supplemental locking mechanism (lock) 230 which may be added to act responsive to detecting of a refrigerant leak by a detector 232 (FIG. 5). The detector is positioned to detect the presence of refrigerant in the interior of the container (particularly in the refrigerated compartment). A number of possible locations exist for such a detector including locations within the equipment box (e.g., adjacent the evaporator in a duct along one of the flowpaths 510A or 510B either inside or outside the equipment module communicating with the rest of the refrigerated compartment or space) or more remote (e.g., even as far away as on or adjacent the doors).

Exemplary detectors comprise infrared sensors along with signal processing and output electronics as may be appropriate. Exemplary infrared sensors are non-dispersive infrared (NDIR) sensors. Exemplary NDIR sensors have target sensing ranges of 3250 nm to 3650 nm or 6500 nm to 7650 nm. These ranges are approximate and are generally correlated with key hydrocarbon peaks for detecting hydrocarbon refrigerants. An alternative NDIR sensor is a two-channel sensor with one channel serving the function above and the other channel functioning as a more standard sensor used to sense container interior temperature. An alternative sensor would be a metal oxide sensor or an electrochemical sensor.

Although there may be various hardwired/hardcoded or analog implementations with little control logic, an exemplary implementation involves the detector 232 communicating with a programmed controller (which in turn communicates with the supplemental lock 230. The controller may be the main controller 64 of the refrigeration system or may be a separate unit 234 (FIG. 5, e.g., having a processor, memory and storage for running a program to perform the required functions).

The exemplary supplemental lock 230 interacts with the locking bars of a baseline container configuration. The number of such supplemental locks depends upon the configuration of the doors and the existing latching mechanism. For example, some containers may be configured so that the doors may independently open. In such a situation, at a minimum, one supplemental lock is provided per door to lock at least one of the locking bars of such door. In the exemplary situation, however, one of the doors 28A (FIG. 2) is the dominant door and carries a feature (e.g., a lip) 240 that prevents opening of the other door 28B when the dominant door is closed. In such a situation, the supplemental lock may lock only the dominant door. The exemplary implementation places the supplemental lock 230 as an electronically or electrically actuated mechanism adjacent the existing or baseline catch to supplement the existing catch by locking the handle and/or rod in addition to the latching provided by the catch.

Alternative supplemental locks may replace the existing or baseline catch and serve the function thereof in addition to the safety functions described below.

An exemplary supplemental lock 230 is in wireless communication with the controller and, therefore, includes its own battery and electronics (e.g., including a wireless receiver) and an actuator 250 (FIG. 6) for shifting a locking member 252 (e.g., a pin) between a locking condition and an unlocking condition (unlocking or retracted shown in solid line in FIG. 6 with locking or extended in broken line). By having its own battery, separate from the main battery 66, operation of the supplemental lock can be assured even if the main battery discharges (as is often the case where the container sits unused and disconnected from external power). For this purpose the battery may be a long life disposable battery such as an alkaline battery. For similar reasons, this battery or similar batteries may power the detector 232, other associated safety equipment, and the controller 234 as is discussed further below.

Exemplary actuators include servomotors or solenoids and may be formed for worm drive, gear drive, linear drive, or the like. An exemplary locking condition is an extended condition extending through apertures in the handle and retainer. An exemplary unlocking condition is a retracted condition.

As a practical matter, the controller is more likely to be in hardwired communication with the detector rather than wireless communication. The controller may conveniently be located in the equipment box in reasonable wiring proximity to a detector in the box. The controller may have its own battery 258 (FIG. 5). Similarly, a detector wirelessly coupled to the controller may have its own battery and radio electronics. There may be multiple detectors coupled to a given controller.

Upon detection of the presence of the refrigerant (or a threshold level thereof) by the detector, the controller may cause the supplemental lock 230 actuator 250 to shift the locking member 252 from its unlocking condition to its locking condition. One or more of several unlocking options are possible, including: unlocking when the detector no longer detects threshold refrigerant; unlocking in response to a user-entered override (e.g., via a switch or control panel). Additionally, an interior safety release may be provided for a user inside.

As a further option, the detection may cause the controller to command one or more alerts or indicia. One example involves an alert unit 260 (FIG. 2) mounted on the container (e.g., the same door as the supplemental lock (and optionally integrated therewith). The exemplary unit may have a light 262 for visual alert and a speaker or other sound generator or alarm 264 for audio alert. Again, the unit may have its own battery and radio electronics for wireless communication with the controller or may be hardwired.

Yet other systems potentially involve integrating the detector with the supplemental locking mechanism such as for a supplemental locking mechanism mounted in the rear header. Such a system might have a relatively limited controller (e.g., a dedicated controller as distinguished from an overall controller of the refrigeration system).

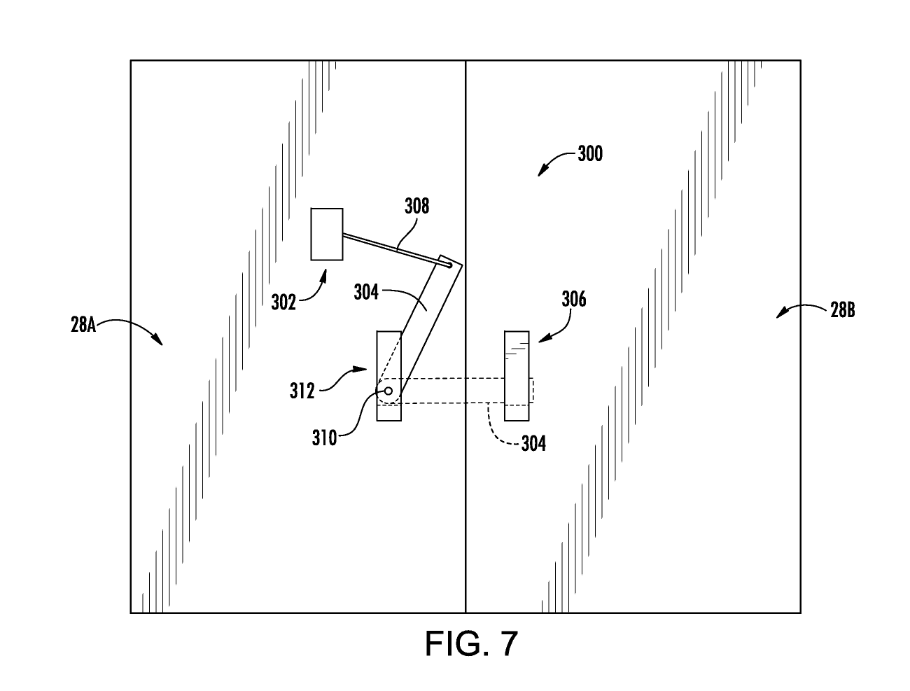

Alternative implementations may have the supplemental lock be independent of the baseline locking bars. For example, one such independent variation (not shown) involves a pair of such supplemental locks locking each door directly to the rear header (or a single lock locking a dominant door to the header). Other exemplary implementations involve a supplemental lock 300 (FIG. 7) for locking the two doors to each other to prevent their opening. The exemplary illustrated example is mounted to the interior of the doors and comprises an actuator assembly 302 and a locking member 304 mounted to one door and a member 306 mounted to the other. The illustrated example has a falling bar locking member with a proximal end portion pivotally mounted to the first door. The actuator may release the locking member, allowing its distal end to rotate downward under the weight of the locking member. The falling locking member is then caught by an upwardly open bracket as the member 306 (e.g., L or U bracket) to lock the two doors to each other (broken line condition). In the illustrated example, the pivot 310 is an axle spanning a similar L or U bracket 312 for strength. An external alert unit 260 (not shown) may also be provided as in the first embodiment.

The exemplary actuator of the assembly 302 comprises an electric motor driving a spool around which a tether (e.g., cable) 308 is wrapped. The tether connects to the locking member. For locking, the controller may cause the motor to unwrap/unwind the tether. For unlocking, the controller may cause the motor to rewind/rewrap the tether to lift the locking member. As with the other embodiments, the actuator assembly may include its own battery, radio, and other electronics.

As a further safety feature, a plurality of valves may be located along the refrigerant flowpath and may be actuated responsive to the detector detecting refrigerant leakage. The valves allow isolation of sections of the refrigerant flowpath to limit leakage generally but also particularly limit leakage into the container. For example, a pair of valves 340 and 341 (FIG. 3) may be located to isolate the evaporator. The valves may be located just outside of the air flowpaths 510A and 510B (e.g., they may be in the exterior side of the equipment box). In such a situation, if a leak occurs in the evaporator, once the leak is detected essentially no refrigerant from other portions of the system would be able to leak into the container interior.

Exemplary valves are normally closed solenoid valves. These may be powered by the main battery of the refrigeration system or by a separate battery. As a practical matter, in operation, the power for such valves may come from the external power (e.g., ship power) or power from a generator as discussed above. Thus, energy consumption while the compressor is running would not be a problem. Again depending upon the implementation, these may be hardwired to the controller or may be subject to wireless control. Such valves are particular candidates for immediate/direct control by the main controller of the refrigeration system. In situations where separate controllers are involved, the controller 234 may communicate with the main controller of the refrigeration system to shut the refrigeration system down in response to leak detection. Such shutdown would involve shutting down the compressor and, subsequently, closing the valves 340 and 341 (or simply allowing them to close).

Yet additional safety features involve the placement of flame arrestors in a number of locations. Background flame arrestor technology which may be utilized is found International Publication No. WO2015/009721A1, published Jan. 22, 2015, the disclosure of which is incorporated herein in its entirety by reference as if set forth at length. One exemplary flame arrestor is one or more woven wire or perforated mesh (e.g., expanded metal mesh) panels 400 (FIG. 4) across openings along the front of the equipment box. This may cover openings to the compressor, heat exchangers, and any piping or other refrigerant carrying components of the vapor compression loop. Mesh opening size will depend on the inherent flammability and expected operating conditions of the particular refrigerant. Other flame arrestor locations include placing such mesh or perforated sheet 402, 404 (FIG. 5) across the internal air flowpath (e.g., in the duct within the equipment box immediately upstream of the fan(s) and another immediately downstream of the evaporator). This would isolate the fan(s) as an ignition source from the bulk of the refrigerated compartment. Similarly, such flame arrestors could be located at the equipment module (box) inlet and outlet to the refrigerated compartment. Additional such flame arrestors would be associated with other ports such as the fresh air exchange vent. Non-metallic and/or non-sheet arrestor materials may also be used. For example, in-duct arrestors are candidates for an HVAC filter (dual purpose filter and flame arrestor) constructed of nonflammable (e.g., glass or steel wool or packed fiber) materials. In duct flows, such devices will create pressure drop (not desirable) and that will need to be considered during design.

As a further safety feature, the detector and controller may be coupled to a ventilation system for venting the interior of the container in response to leak detection. This venting may be done by a dedicated additional venting fan (e.g., along with controllable shutter or other valving). In such a situation, the fan unit would include its own battery and electronics optionally integrated with one of the other components such as the controller, the detector, or the supplemental lock. Alternative implementations may use baseline fresh air exchange vents (e.g., 80A shown above and, its associated blower fan, if any, and/or evaporator fan) to do the venting. For example, one implementation might involve the shutting down of the refrigeration system but the opening of the gate valve 80A and the running of the fan 52A.

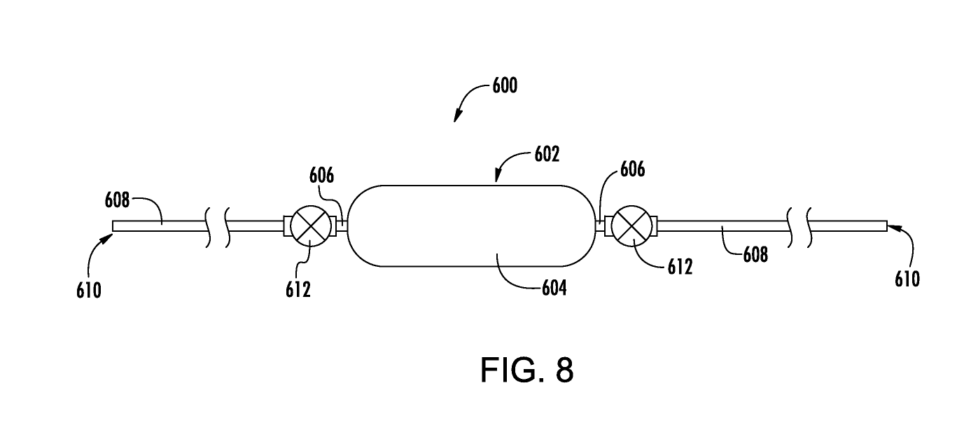

In addition or alternatively to such venting, an active inerting or diluting system 600 (FIG. 5) may include a source 602 (FIG. 8) of one or more gases for diluting the space containing a leaked flammable refrigerant. Exemplary sources include one or more cylinders 604 (FIG. 8) of compressed or liquefied gas. Exemplary gas is nitrogen (N₂). Another candidate gas is carbon dioxide (CO₂). The gas in the source may consist essentially of said nitrogen or carbon dioxide, respectively (e.g., industrial grade or at least with sufficiently low oxygen contaminate to serve the inerting/diluting function). The system 600 may function responsive to leakage detection to create a safe environment by lowering the leaked refrigerant and or oxygen (O₂) concentration (e.g., measured with a sensor 235 in FIG. 5 as in a baseline Controlled Atmosphere system) in the container interior to below an acceptable threshold.

One or more sensors may be used to control the source. Depending upon the particular implementation, these may be shared with other container subsystems. Such sensors may include the refrigerant detector 232 mentioned above (or similar dedicated sensor) or may include other sensors.

An exemplary activation threshold is well below the lower flammability limit (LFL) for the refrigerant-air mixture of concern. An exemplary threshold is well under 0.25 times the LFL (e.g., 0.05 times the LFL or 0.10 times). The threshold may be programmed or otherwise configured into the relevant controller. The threshold may be refrigerant-specific or may represent a worst case scenario value e.g., the most flammable refrigerant that may be used in a plurality of refrigeration systems that share the same inerting system). Exemplary operation involves the controller causing a full discharge of the source upon reaching the threshold rather than actively controlling to conserve inerting gas for future use. The amount of flammable refrigerant is inherently limited to the system charge. A substantial portion of that charge may have already leaked to approach the threshold. The size of the source 602 may be selected to provide a sufficient margin such that after discharge of the source, the threshold is unlikely to be crossed.

The system 600 may have one or more outlets 610 (FIG. 8) and one or more valves 612 (an automatic valve such as a solenoid-type valve (e.g., a normally-closed solenoid valve)) for controlling flow from the source 602 to the outlets. The exemplary cylinder 604 has two cylinder outlets positioned one at each end (e.g., formed at fittings 606 mounted to respective domed ends of the cylinder). The valves 612 may be mounted directly to the fittings or along piping/conduit 608 along inerting gas flowpaths to the respective outlets 610. The outlets 610 may be formed by ends of the piping or nozzles mounted thereto. The exemplary configuration places the outlets 610 along the duct within the equipment box (e.g., between the evaporator and the outlet to the refrigerated compartment. The form of valve 612 may be chosen for low power consumption. This allows extended operation of the inerting system while the container is decoupled from external power. For example, even when not in use and just sitting in a storage facility, the inerting system should still run for extended times on battery power.

Similarly, the system 600 may share a system/main controller 64 and battery 66 or may have a separate controller (e.g., 234) and battery (e.g., 258). Such controller and battery may be shared with other safety subsystems (if any) as noted above or may be yet separate therefrom.

An exemplary inerting charge may be selected to address a worst case scenario of an empty container (a relatively full container having less available oxygen to be diluted and thus requiring less inerting agent). If the same equipment box (or merely inerting system) may be used for multiple sizes of container, the inerting system may be sized for the largest (e.g., a nominal 40 ft. (nominal 12 m) intermodal container vs. a nominal 20 ft. (nominal 6 m)). If the same model of inerting system is to be used with different refrigerants, the size may be selected for inerting a worst case scenario of the most flammable refrigerant. A charge of about 65 kg of nitrogen would inert an empty 40 ft. container down to about 11% vol. oxygen and thus below the limiting oxygen concentration for most hydrocarbon and hydrofluorocarbon fuels. The limiting oxygen concentration is the minimum concentration in a mixture of fuel, oxygen and an inert that will propagate flame. An exemplary range lower end for N₂ charge is at least 6.5 kg or at least 30 kg or at least 50 kg. Exemplary range upper ends usable with any of such lower ends are 70 kg or 100 kg. CO₂ charges if used alternatively would scale based on relative molecular weight to achieve similar volumetric dilution.

The cylinder 604 may be a high pressure cylinder (e.g., charged to at least 2200 psi (15 MPa) full for N₂) to save space and ensure a choked discharge flow. To ensure that the inerting gas discharge rate is sufficient, the size of the line may be selected to be larger than a typical refrigerant line (e.g. at least 0.5 inch (12.5 mm) inner diameter (ID).

The inerting system may also serve fire suppression/extinguishing purposes independent of the refrigerant leak detection. For example, there might be a cargo fire or an electrical fire involving the container. Various known sensor technologies may be used to detect a fire. One example of an existing component is a carbon dioxide sensor 237 (FIG. 5) used in CA applications. An exemplary carbon dioxide threshold programmed or other configured into the controller is two volume percent (e.g., 2.0%). Upon detecting CO₂ at or above this threshold, the valve(s) 612 may be opened by the controller. That exemplary threshold is lower than CO₂ levels often featured in CA applications. Thus, the controller may be programmed to override this threshold triggering if the system is being used in a CA application that permits or seeks a higher CO₂ level. Alternative sensors include more conventional fire detections sensors such as smoke (e.g., ionization type) or carbon monoxide sensors.

Additional use of components to prevent or block sparking or arcing may be provided, including use of known forms of explosion-proof motors. Relevant motors for scrutiny include: the compressor motor; fan motors; and actuator motors. This may include replacing or modifying baseline motors and adding motors associated with features such as supplemental vents, supplemental fans, and the like.

Arcing would be undesirable in motor commutation. Particularly for evaporator fan motors (and other motors in the refrigerated compartment), induction motors would be good choices.

Such a motor may have a totally enclosed frame and be sealed from any vapor penetration, this would include seals to shafts that would drive the fans. All connections to such motors may be sealed from any vapor penetration. This sealing would include the conduit via which wire enters the motor connection box

Totally hermetic heaters would be used along the recirculating flowpaths (used for evaporator defrost and heating when external temperatures are so low that the compartment must be heated rather than cooled). Thus, any failure mode would not result in an electrical arc.

Some-to-all electrical interconnections (wire, cable) may be sealed in exposition proof conduit. All penetrations in or out the evaporator side of the equipment module would be explosion proof (no vapor penetration).

Some-to-all sensors may be sealed from vapor penetration so that any failure mode would not result in an electrical arc in a location of possible refrigerant exposure. In addition to sensors associated with the detector(s) 230 or other non-baseline components, this may include sensors of the baseline module. Exemplary baseline sensors include the DTS (defrost termination sensor) on the evaporator coil, HTT (high temperature termination sensor) on the evaporator coil and temperature measurement sensor located slightly downstream of the evaporator.

The system may be made using otherwise conventional or yet-developed materials and techniques.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic refrigeration system and/or container construction and associated use methods, details of such existing configuration or its associated use may influence details of particular implementations. Accordingly, other embodiments are within the scope of the following claims.

1. A refrigerated transport system (20) comprising:
a body (22) enclosing a refrigerated compartment and comprising:
a pair of side walls (22C, 22D);
a top (22A);
a bottom (22B); and
one or more doors (28A, 28B);
a refrigeration system (30) comprising:
a charge of refrigerant;
a compressor (36) for driving the refrigerant along a refrigerant flowpath (34);
a first heat exchanger (38) along the refrigerant flowpath and positioned to reject heat to an external environment in a cooling mode; and
a second heat exchanger (42) along the refrigerant flowpath and positioned to absorb heat from the refrigerated compartment in the cooling mode;
a detector (232) for detecting leakage of the refrigerant; and
a locking mechanism (230; 300) having a first condition locking the doors and a second condition allowing opening of the doors and coupled to the detector, the locking mechanism comprising a locking member that is driven by its own weight to shift from the first condition to the second condition, and the locking mechanism being coupled to the detector to shift from the second condition to the first condition responsive to detection by the detector of the refrigerant outside the refrigerant flowpath.

2. The refrigerated transport system of claim 1, further comprising:
a dilution gas source (602) coupled to the detector.

3. The refrigerated transport system of claim 2, wherein:
the dilution gas consists essentially of nitrogen.

4. The refrigerated transport system of claim 2, further comprising:
an automatic valve (612) coupled to control flow from the dilution gas source (602).

5. The refrigerated transport system of claim 4, wherein:
the dilution gas source is coupled via the automatic valve (612) to one or more outlets (610) positioned along an equipment box duct.

6. The refrigerated transport system of claim 4, wherein:
the dilution gas source comprises a cylinder (604) having a first outlet and a second outlet;
a first said automatic valve is positioned to control flow from the first outlet and a second said automatic valve is positioned to control flow from the second outlet.

7. The refrigerated transport system of claim 4, further comprising:
a controller (64; 234) coupling the detector to the automatic valve (612) to control flow from the dilution gas source (602).

8. (canceled)

9. The refrigerated transport system of claim 1, further comprising:
a first valve (340) along the refrigerant flowpath and a second valve (341) along the refrigerant flowpath and coupled to the detector.

10. The refrigerated transport system of claim 9 wherein:
the first valve and the second valve are normally closed valves coupled to the detector to close responsive to detection by the detector of the refrigerant outside the refrigerant flowpath.

11. (canceled)

12. (canceled)

13. (canceled)

14. (canceled)

15. (canceled)

16. The refrigerated transport system of claim 1, further comprising:
a battery-powered ventilation fan.

17. The refrigerated transport system of claim 1, further comprising:
a first electric fan (50) positioned to drive an air flow across the first heat exchanger; and
a second electric fan (52A, 52B) positioned to drive a recirculating air flow from the refrigerated compartment across the second heat exchanger.

18. The refrigerated transport system of claim 1, further comprising:
a battery (258), distinct from a battery (66) of a main controller (64), if any, and coupled to the detector.

19. The refrigerated transport system of claim 1, wherein:
a refrigerant charge of the refrigeration system has a flammability classification of at least mildly flammable.

20. (canceled)

21. (canceled)

22. (canceled)

23. (canceled)

24. The refrigerated transport system of claim 1, being a refrigerated intermodal shipping container wherein:
the one or more doors comprise a pair of hinged doors at a first end of the body; and
the refrigeration system is mounted in an equipment box at a second end of the body opposite the first end.

25. The refrigerated transport system of claim 1, wherein:
the detector comprises a non-dispersive infrared sensor.

26. (canceled)

27. (canceled)

28. A refrigerated transport system (20) comprising:
a body enclosing a refrigerated compartment and comprising:
a pair of side walls;
a top;
a bottom; and
one or more doors;
a refrigeration system comprising:
a charge of refrigerant;
a compressor for driving the refrigerant along a refrigerant flowpath;
a first heat exchanger along the refrigerant flowpath and positioned to reject heat to an external environment in a cooling mode; and
a second heat exchanger along the refrigerant flowpath and positioned to absorb heat from the refrigerated compartment in the cooling mode;
a detector for detecting leakage of the refrigerant; and
a locking mechanism:
having a first condition locking the doors and a second condition allowing opening of the doors;
coupled to the detector coupled to the detector to shift from the second condition to the first condition responsive to detection by the detector of the refrigerant outside the refrigerant flowpath; and
comprising:
a plurality of locking bars mounted for respective rotation about respective central vertical axes;
a plurality of handles, each mounted to a respective associated one of said locking bars, each handle having a locked condition corresponding to a locked condition of the respective associated locking bar;
a locking member shiftable between a locking condition and an unlocking condition, in the locking condition preventing shifting of the handle from the locked condition to the unlocked condition; and
an actuator for shifting the locking member between the locking condition and the unlocking condition and coupled to the detector.

29. The refrigerated transport system of claim 28 wherein:
the locking member locking condition is an extended condition and the locking member unlocking condition is a retracted condition.

30. The refrigerated transport system of claim 29 wherein:
the locking mechanism further comprises, for at least one of the handles, a releasable catch for holding the handle in the locked condition; and
in the extended condition, the locking member blocks release of the catch.

31. A refrigerated transport system comprising:
a body enclosing a refrigerated compartment and comprising:
a pair of side walls;
a top;
a bottom; and
one or more doors;
a refrigeration system comprising:
a charge of refrigerant;
a compressor for driving the refrigerant along a refrigerant flowpath (34);
a first heat exchanger along the refrigerant flowpath and positioned to reject heat to an external environment in a cooling mode; and
a second heat exchanger along the refrigerant flowpath and positioned to absorb heat from the refrigerated compartment in the cooling mode;
a detector for detecting leakage of the refrigerant; and
a locking mechanism:
having a first condition locking the doors and a second condition allowing opening of the doors;
coupled to the detector coupled to the detector to shift from the second condition to the first condition responsive to detection by the detector of the refrigerant outside the refrigerant flowpath; and
comprising a supplemental lock within the compartment.

32. The refrigerated transport system of claim 31 wherein:
the supplemental lock has a falling bar locking member and an actuator for releasing the locking member to rotate downward under the weight of the locking member.
